(19) United States
(12) Patent Application Publication
(10) Pub. No.: US 2021/0281105 A1
(43) Pub. Date: Sep. 9, 2021

(54) CIRCUIT DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Kota Oda, Yokkaichi-shi, Mie (JP); Gozo Ozeki, Yokkaichi-shi, Mie (JP); Keisuke Wakazono, Yokkaichi-shi, Mie (JP)

(21) Appl. No.: 17/258,998

(22) PCT Filed: Jul. 5, 2019
(86) PCT No.: PCT/JP2019/026865

§ 371 Date: Jan. 8, 2021

(30) Foreign Application Priority Data
Jul. 25, 2018 (JP) 2018-139769

(51) Int. Cl. H02J 9/06; H02J 7/34; G05F 3/20; G05F 3/18

(52) U.S. Cl. CPC H02J 9/06; G05F 3/18; G05F 3/20; H02J 7/34

(57) ABSTRACT

In a power supply control device, when the connection of a battery is a normal connection, and a bypass switch is off, a current flows through a first switching circuit and a diode in that order. When the connection of the battery is a normal connection, and an output voltage of the battery drops below a reference voltage, a second switching circuit switches the bypass switch from off to on.

### CROSS-REFERENCE TO RELATED APPLICATIONS

This application is the U.S. national stage of PCT/JP2019/026865 filed on Jul. 5, 2019, which claims priority of Japanese Patent Application No. JP 2018-139769 filed on Jul. 25, 2018, the contents of which are incorporated herein.

### TECHNICAL FIELD

The present disclosure relates to a circuit device.

### BACKGROUND

JP 2011-225043A discloses a circuit device for vehicles that includes an electric circuit. In this circuit device, the cathode of a diode is connected to the electric circuit. When the positive electrode of a battery is connected to the anode of the diode, power is supplied from the battery to the electric circuit via the diode, and the electric circuit operates.

When the negative electrode of the battery is mistakenly connected to the anode of the diode, no current flows from the battery to the electric circuit by the action of the diode. Therefore, no voltage with wrong polarity is applied to the electric circuit.

When a current flows through a diode, a voltage drop occurs at the diode. Therefore, when power is supplied from a battery to an electric circuit via the diode, the voltage that is applied to the electric circuit is lower than the output voltage of the battery. Usually, an output voltage of a battery mounted in a vehicle is not fixed, but changes. When the output voltage of the battery drops, the voltage that is applied to the electric circuit also drops.

In the circuit device described in JP 2011-225043A, when the output voltage of the battery drops, it is likely that the voltage that is applied to the electric circuit drops below an operating voltage required for operating the electric circuit. When the voltage that is applied to the electric circuit drops below the operating voltage, the electric circuit suddenly stops operating.

In view of this, an object of the present disclosure is to provide a circuit device in which an electric circuit is unlikely to suddenly stop operating.

### SUMMARY

A circuit device according to one aspect of the present disclosure is a circuit device that includes an electric circuit that is supplied with power when a DC voltage is applied between two terminals thereof, and the circuit device includes a diode that is disposed on a supply path for supplying power to the electric circuit, a switch that is connected to two ends of the diode, and a switching circuit that switches the switch from off to on when the DC voltage is applied in a specific direction and drops below a predetermined voltage, and, when the DC voltage is applied in the specific direction, and the switch is off, a current flows through the electric circuit and the diode in that order.

### Advantageous Effects of Disclosure

According to the present disclosure, it is not likely that an electric circuit suddenly stops operating.

### BRIEF DESCRIPTION OF DRAWINGS

FIG. 1 is a block diagram showing the main constituent elements of a power source system according to a first embodiment.

FIG. 2 is a circuit diagram of a second switching circuit.

FIG. 3 is a timing chart for illustrating operations of a second switching circuit.

FIG. 4 is a diagram illustrating the effects of a power supply control device.

FIG. 5 is a circuit diagram of a second switching circuit according to a second embodiment.

FIG. 6 is a block diagram showing the main constituent elements of a power source system according to a third embodiment.

FIG. 7 is a block diagram showing the main constituent elements of a power source system according to a fifth embodiment.

### DETAILED DESCRIPTION OF PREFERRED EMBODIMENTS

First, embodiments of the present disclosure will be listed. At least some of the embodiments to be described below may be suitably combined.

A circuit device according to one aspect of the present disclosure is a circuit device that includes an electric circuit that is supplied with power when a DC voltage is applied between two terminals thereof, and the circuit device includes a diode that is disposed on a supply path for supplying power to the electric circuit, a switch that is connected to two ends of the diode, and a switching circuit that switches the switch from off to on when the DC voltage is applied in a specific direction and drops below a predetermined voltage, and, when the DC voltage is applied in the specific direction, and the switch is off, a current flows through the electric circuit and the diode in that order.

In the above aspect, when a DC voltage is applied in a direction other than the specific direction, and the switch is off, no current flows through the electric circuit by the action of the diode. Therefore, it is possible to prevent a voltage with wrong polarity from being applied to the electric circuit. When a DC voltage is applied in the specific direction, and the switch is off, a current flows through the electric circuit and the diode in that order, and a voltage drop occurs at the diode. When a DC voltage is applied in the specific direction, and the switch is on, a current flows through the electric circuit and the switch in that order, and no voltage drop occurs at the diode.

When a DC voltage is applied in the specific direction and drops below the predetermined voltage, the switch is switched from off to on, and the voltage that is applied to the electric circuit rises. Therefore, it is not likely that the voltage that is applied to the electric circuit drops below an operating voltage required for operating the electric circuit, and the operation of the electric circuit stops.

In the circuit device according to another aspect of the present disclosure, the switch is a transistor, and includes a first end that is disposed on an anode side of the diode on the supply path, a second end that is disposed on a cathode side of the diode on the supply path, and a third end, when a voltage at the third end rises, a resistance value between the first end and the second end drops, and the switching circuit switches the switch from off to on by raising the voltage at the third end.

In the above aspect, the switch is an N-channel FET (field effect transistor), an NPN bipolar transistor, or the like. The switching circuit switches the switch from off to on by raising the voltage at the third end that corresponds to a gate, base, or the like.

In the circuit device according to another aspect of the present disclosure, the switch is an N-channel FET, and the diode is a parasitic diode of the switch.

In the above aspect, the switch is an N-channel FET. The parasitic diode of the switch is used as the diode that is disposed on the supply path. Therefore, the manufacturing cost is low.

In the circuit device according to another aspect of the present disclosure, the switching circuit includes a resistor whose one end is connected to the third end of the switch and a second switch whose one end is connected to the third end of the switch, when the DC voltage is applied in the specific direction, a positive voltage with respect to a potential of another end of the second switch is applied to the other end of the resistor, and when the DC voltage is applied in the specific direction, and the DC voltage drops below a predetermined voltage, the second switch is switched from on to off.

In the above aspect, when the second switch is on, the voltage that is applied to the third end of the switch is low, and thus the switch is off. When a DC voltage is applied in the specific direction and drops below the predetermined voltage, the second switch is switched off. At this time, the voltage at the third end of the switch rises to a voltage that is as high as the DC voltage, and the switch is switched on.

In the circuit device according to another aspect of the present disclosure, the switching circuit includes a second switch whose one end is connected to the third end of the switch, when the DC voltage is applied in the specific direction, a positive voltage with respect to a potential of a cathode of the diode is applied to another end of the second switch, and, when the DC voltage is applied in the specific direction and drops below a predetermined voltage, the second switch is switched from off to on.

In the above aspect, when the second switch is off, the voltage that is applied to the third end of the switch is low, and thus the switch is off. When a DC voltage is applied in the specific direction and drops below the predetermined voltage, the second switch is switched on. At this time, the voltage at the third end of the switch rises to a high voltage that is as high as the DC voltage, and the switch is switched on.

In the circuit device according to another aspect of the present disclosure, the switching circuit includes a Zener diode and a second resistor whose one end is connected to an anode of the Zener diode, when the DC voltage is applied in the specific direction, a positive voltage with respect to a potential of the other end of the second resistor is applied to a cathode of the Zener diode, and the second switch is switched on or off in accordance with a voltage at the one end of the second resistor.

In the above aspect, when a DC voltage is applied in the specific direction, and the DC voltage is higher than or equal to a predetermined voltage, a current flows through the Zener diode and the second resistor in that order, and the voltage at the one end of the second resistor is high. At this time, the switch is off. When a DC voltage is applied in the specific direction and drops below the predetermined voltage, flow of the current through the Zener diode stops, and the voltage at the one end of the second resistor drops. At this time, the second switch is switched on or off, and the switch is switched on.

The circuit device according to another aspect of the present disclosure includes a third switch, and the electric circuit switches the third switch on or off, and when the DC voltage is applied to the two terminals, power is supplied to an electric apparatus via the third switch.

In the above aspect, the electric circuit controls supply of power to the electric apparatus, by switching the third switch on or off.

Specific examples of a power source system according to embodiments of the present disclosure will be described below with reference to the drawings. Note that the present disclosure is not limited to illustrations of these, but is indicated by the claims, and is intended to include all modifications that are within the meanings and the scope that are equivalent to those of the claims.

### First Embodiment

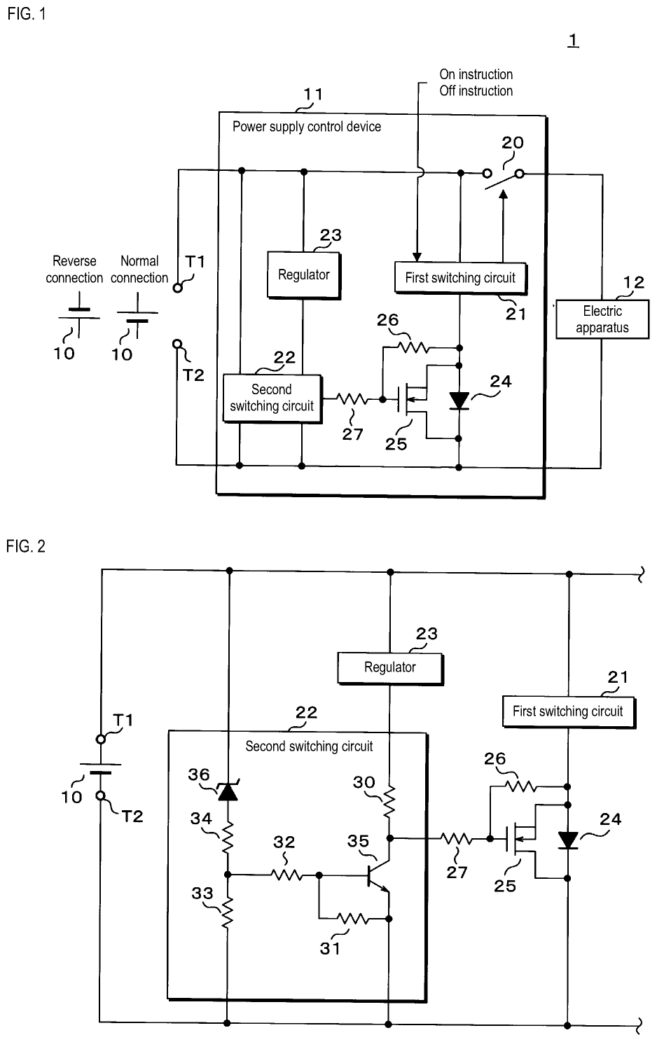

FIG. 1 is a block diagram showing the main constituent elements of a power source system 1 according to a first embodiment. The power source system 1 is mounted in a vehicle in a suitable manner, and includes a battery 10, a power supply control device 11, an electric apparatus 12, a positive terminal T1, and a negative terminal T2. The battery 10 is detachably connected between the positive terminal T1 and the negative terminal T2. Hereinafter, the voltage of the positive electrode of the battery 10 with respect to the potential of the negative electrode of the battery 10 is referred to as “battery voltage”. The battery voltage is a DC voltage.

When the positive electrode and negative electrode of the battery 10 are respectively connected to the positive terminal T1 and the negative terminal T2, the connection of the battery 10 is a normal connection. When the positive electrode and negative electrode of the battery 10 are respectively connected to the negative terminal T2 and the positive terminal T1 mistakenly, the connection of the battery 10 is a reverse connection. When the battery 10 is connected to the positive terminal T1 and the negative terminal T2, a battery voltage is applied between the positive terminal T1 and the negative terminal T2. When the connection of the battery 10 is a normal connection, a battery voltage is applied in a specific direction. When the connection of the battery 10 is a reverse connection, a battery voltage is applied in a direction different from the specific direction.

The power supply control device 11 includes a power supply switch 20, a first switching circuit 21, a second switching circuit 22, a regulator 23, a diode 24, a bypass switch 25, and resistors 26 and 27. The bypass switch 25 is an N-channel FET, and includes a source, a drain, and a gate. The diode 24 is a parasitic diode of the bypass switch 25. The parasitic diode of the bypass switch 25 is used as the diode 24, and thus the manufacturing cost of the power supply control device 11 is low.

In the power source system 1, the positive terminal T1 is connected to one end of the power supply switch 20 of the power supply control device 11. The other end of the power supply switch 20 is connected to one end of the electric apparatus 12. The other end of the electric apparatus 12 is connected to the negative terminal T2.

In the power supply control device 11, the one end of the power supply switch 20 is further connected to the first switching circuit 21, the second switching circuit 22, and the regulator 23. The first switching circuit 21 is further connected to the anode of the diode 24. The cathode of the diode 24 is connected to the negative terminal T2. The source and drain of the bypass switch 25 are respectively connected to the anode and cathode of the diode 24. The resistor 26 is connected between the gate and the source of the bypass switch 25. The gate of the bypass switch 25 is further connected to one end of the resistor 27. The other end of the resistor 27 is connected to the second switching circuit 22. The regulator 23 is further connected to the second switching circuit 22. The second switching circuit 22 is further connected to the negative terminal T2.

When the connection of the battery 10 is a normal connection, a current flows from the positive electrode of the battery 10 to the first switching circuit 21, and the battery 10 applies a voltage to the first switching circuit 21. Accordingly, power is supplied to the first switching circuit 21. The first switching circuit 21 operates when the voltage that is being applied to the first switching circuit 21 is higher than or equal to an operating voltage required for operating the first switching circuit 21.

An “on” instruction to turn on the power supply switch 20 and an “off” instruction to turn off the power supply switch 20 are input to the first switching circuit 21. When the “on” instruction is input to the first switching circuit 21, the first switching circuit 21 switches the power supply switch 20 on. When the connection of the battery 10 is a normal connection, and the power supply switch 20 is switched on, the battery 10 supplies power to the electric apparatus 12 via the power supply switch 20. Accordingly, the electric apparatus 12 operates.

When the “off” instruction is input to the first switching circuit 21, the first switching circuit 21 switches the power supply switch 20 off. When the connection of the battery 10 is a normal connection, and the power supply switch 20 is switched off, supply of power from the battery 10 to the electric apparatus 12 stops. Accordingly, the electric apparatus 12 stops operating.

The power supply control device 11 controls supply of power from the battery 10 to the electric apparatus 12 as a result of the first switching circuit 21 switching the power supply switch 20 on or off.

The power supply control device 11, the power supply switch 20, and the first switching circuit 21 respectively function as a circuit device, a third switch, and an electric circuit.

When the voltage that is applied to the first switching circuit 21 drops below the operating voltage, or supply of power from the battery 10 to the first switching circuit 21 stops, the first switching circuit 21 stops operating. When the first switching circuit 21 has stopped operating, the power supply switch 20 is off, and no power is supplied to the electric apparatus 12.

When the connection of the battery 10 is a normal connection, and the battery voltage exceeds a set voltage that was set in advance, the regulator 23 steps down the battery voltage to the set voltage. The set voltage is a voltage with respect to the potential of the negative terminal T2. The battery voltage is 12 V, for example. The set voltage is 5 V, for example.

The regulator 23 includes a diode (not illustrated). The cathode of this diode is connected to the second switching circuit 22. The regulator 23 outputs the stepped-down voltage to the second switching circuit 22 via the diode. When the connection of the battery 10 is a normal connection, and the battery voltage is lower than or equal to the set voltage, the regulator 23 outputs the battery voltage to the second switching circuit 22 via the diode.

As described above, the cathode of the diode of the regulator 23 is connected to the second switching circuit 22, and thus no current flows through the second switching circuit 22 and the regulator 23 in that order.

When the voltage at the gate at the bypass switch 25 with respect to the potential of the source rises, the resistance value between the drain and the source drops. When the voltage at the gate of the bypass switch 25 with respect to the potential of the source is higher than or equal to a first threshold value, the resistance value between the drain and the source is low, and a current can flow through the drain and source. At this time, the bypass switch 25 is on.

In addition, when the voltage at the gate of the bypass switch 25 with respect to the potential of the source is lower than the first threshold value, the resistance value between the drain and the source is high, and no current flows through the drain and source. At this time, the bypass switch 25 is off. The first threshold value is a fixed voltage, and exceeds zero V.

In the diode 24, when a current flows through the anode and cathode in that order, a voltage drop occurs. Hereinafter, the range of this voltage drop is referred to as “forward voltage”. The forward voltage is 0.6 V, for example.

When the connection of the battery 10 is a normal connection, and the battery voltage rises to a reference voltage or higher, the second switching circuit 22 drops, substantially to zero V, the voltage at the gate of the bypass switch 25 with respect to the potential of the negative terminal T2. At this time, the voltage at the gate of the bypass switch 25 with respect to the potential of the source drops below the first threshold value, and the bypass switch 25 is switched from on to off. The reference voltage is fixed.

When the connection of the battery 10 is a normal connection, and the bypass switch 25 is off, a current flows through the positive terminal T1, the first switching circuit 21, the diode 24, and the negative terminal T2 in that order, and power is supplied to the first switching circuit 21.

A path through which a current flows through the positive terminal T1, the first switching circuit 21, the diode 24, and the negative terminal T2 in that order is a supply path through which the battery 10 supplies power to the first switching circuit 21. The diode 24 is disposed on the supply path. On the supply path, the source of the bypass switch 25 is disposed on the anode side of the diode 24 on the supply path, and the drain of the bypass switch 25 is disposed on the cathode side of the diode 24. The source, drain, and gate of the bypass switch 25 correspond to a first end, a second end and a third end.

When a current flows through the positive terminal T1, the first switching circuit 21, the diode 24, and the negative terminal T2 in that order, a voltage drop occurs at the diode 24. In this case, the voltage that is applied to the first switching circuit 21 is lower than the battery voltage. Specifically, the applied voltage is substantially the same as a voltage calculated by subtracting the forward voltage of the diode 24 from the battery voltage.

When the connection of the battery 10 is a normal connection, and the battery voltage drops below the reference voltage, the second switching circuit 22 raises the voltage at the gate of the bypass switch 25 with respect to the potential of the negative terminal T2, to a voltage that is close to the output voltage of the regulator 23. Accordingly, the voltage at the gate of the bypass switch 25 with respect to the potential of the source rises to a voltage that is higher than or equal to the first threshold value, and the bypass switch 25 is switched from off to on.

When the bypass switch 25 is on, the resistance value of the bypass switch 25 is sufficiently low. Therefore, when the connection of the battery 10 is a normal connection, and the bypass switch 25 is on, a current flows through the positive terminal T1, the first switching circuit 21, the bypass switch 25, and the negative terminal T2 in that order, and power is supplied to the first switching circuit 21. At this time, a voltage drop does not occur at the diode 24, and thus the voltage that is applied to the first switching circuit 21 is substantially the same as the battery voltage.

When the connection of the battery 10 is a reverse connection, the second switching circuit 22 outputs no voltage to the gate of the bypass switch 25. In this case, no current flows through the resistors 26 and 27, and thus, the voltage at the gate of the bypass switch 25 with respect to the potential of the source is zero V, and is lower than the first threshold value, which is a positive value. Therefore, when the connection of the battery 10 is a reverse connection, the bypass switch 25 is off.

When the connection of the battery 10 is a reverse connection, no current flows through the diode 24 or the bypass switch 25. Therefore, when the connection of the battery 10 is a reverse connection, no current flows through the first switching circuit 21, and it is possible to prevent a voltage with wrong polarity from being applied to the first switching circuit 21.

When the connection of the battery 10 is a reverse connection, no current flows through the first switching circuit 21, and thus no power is supplied to the first switching circuit 21. As described above, when no power is supplied to the first switching circuit 21, the power supply switch 20 is off. Therefore, when the connection of the battery 10 is a reverse connection, no current flows through the electric apparatus 12, and no power is supplied to the electric apparatus 12. When no power is supplied to the electric apparatus 12, the electric apparatus 12 does not operate.

FIG. 2 is circuit diagram of the second switching circuit 22. The second switching circuit 22 includes five resistors 30 to 34, a selector switch 35, and a Zener diode 36. The selector switch 35 is an NPN bipolar transistor.

One end of the resistor 30 and the collector of the selector switch 35 are connected to the other end of the resistor 27. As described above, the one end of the resistor 27 is connected to the gate of the bypass switch 25. Therefore, the one end of the resistor 30 and the collector of the selector switch 35 are connected to the gate of the bypass switch 25 via the resistor 27. The selector switch 35 functions as a second switch.

The other end of the resistor 30 is connected to the regulator 23. The emitter of the selector switch 35 is connected to the negative terminal T2. The resistor 31 is connected between the base and the emitter of the selector switch 35. The base of the selector switch 35 is further connected to one end of the resistor 32. The other end of the resistor 32 is connected to one end of each of the resistors 33 and 34. The other end of the resistor 33 is connected to the negative terminal T2. The other end of the resistor 34 is connected to the anode of the Zener diode 36. Therefore, the anode of the Zener diode 36 is connected to one end of the resistor 33 via the resistor 34. The cathode of the Zener diode 36 is connected to the positive terminal T1.

When the connection of the battery 10 is a normal connection, the regulator 23 steps down the battery voltage to the set voltage, and applies the stepped-down voltage to the other end of the resistor 30. The stepped-down voltage is a positive voltage with respect to the potential of the negative terminal T2, namely, the potential of the emitter of the selector switch 35.

When the voltage at the base with respect to the potential of the emitter of the selector switch 35 rises, the resistance value between the collector and the emitter drops. When the voltage at the base with respect to the potential of the emitter of the selector switch 35 is higher than or equal to a second threshold value, the resistance value between the collector and the emitter is small, and a current can flow through the collector and emitter. At this time, the selector switch 35 is on.

Also, When the voltage at the base with respect to the potential of the emitter of the selector switch 35 is lower than the second threshold value, the resistance value between the collector and the emitter is high, and no current flows through the collector and emitter. At this time, the selector switch 35 is off. The second threshold value is a fixed voltage, and exceeds zero V.

The selector switch 35 is switched on or off in accordance with the voltage at the one end of the resistor 33 with respect to the potential of the negative terminal T2. When the voltage at the one end of the resistor 33 exceeds zero V, a current flows through the resistors 32 and 31 in that order, and a voltage drop occurs at the resistor 31. At this time, a positive voltage is applied to the base with respect to the potential of the emitter of the selector switch 35. The larger the range of the voltage drop at the resistor 31 is, the higher the positive voltage is. The higher the current flowing through the resistor 31 is, the larger the range of the voltage drop at the resistor 31 is.

The higher the voltage at the one end of the resistor 33 with respect to the potential of the negative terminal T2 is, the higher the current flowing through the resistor 31 and the voltage at the base with respect to the potential of the emitter are. As described above, the selector switch 35 is switched on or off in accordance with the voltage at the base with respect to the potential of the emitter.

When the voltage at the cathode with respect to the potential of the anode of the Zener diode 36 rises to a fixed breakdown voltage or higher, a current flows through the cathode and anode in that order. When a current flows through the cathode and anode of the Zener diode 36 in that order, the voltage between the two ends of the Zener diode 36 is maintained at the breakdown voltage. When the voltage at the cathode with respect to the potential of the anode of the Zener diode 36 drops below the breakdown voltage, flow of the current through the cathode and anode stops.

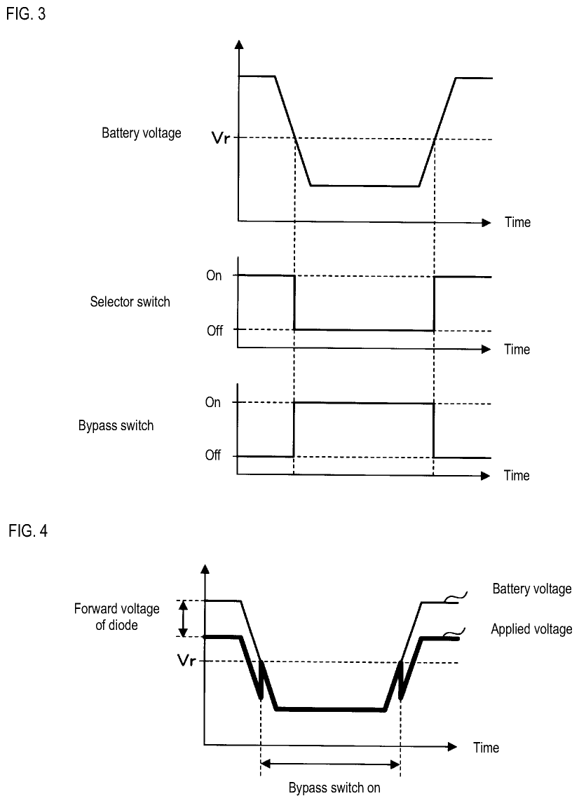

FIG. 3 is a timing chart for illustrating the operation of the second switching circuit 22. FIG. 3 shows the battery voltage, and how the selector switch 35 and the bypass switch 25 are switched on and off. In these graphs, the horizontal axis indicates time. FIG. 3 shows the battery voltage when the connection of the battery 10 is a normal connection. Vr indicates a reference voltage.

The battery voltage may change for various reasons. In the battery 10, a current is output via an internal resistance (not illustrated). When a current flows through the internal resistance, a voltage drop occurs at the internal resistance. The higher the current flowing through the internal resistance is, the larger the range of the voltage drop is. The larger the range of the voltage drop is, the lower the battery voltage is. Therefore, when the current that is output via the internal resistance changes, the range of the voltage drop changes, and the battery voltage changes.

For example, if a target that is supplied with power from the battery 10 includes a starter that is different from the electric apparatus 12, and when the starter operates, a large current flows through the internal resistance of the battery 10, and the battery voltage drops considerably. The starter is a motor for starting the engine. When the starter stops operating, the current flowing through the internal resistance of the battery 10 drops, and the battery voltage rises largely.

In addition, the battery voltage also changes in accordance with the power accumulated in the battery 10.

As shown in FIG. 2, when the connection of the battery 10 is a normal connection, the battery voltage, which is a positive voltage, is applied to the cathode of the Zener diode 36 with respect to the potential of the negative terminal T2, namely the other end of the resistor 33. When the connection of the battery 10 is a normal connection, and the battery voltage is higher than or equal to the reference voltage Vr, then, the voltage at the cathode with respect to the potential of the anode of the Zener diode 36 is higher than or equal to the breakdown voltage. At this time, a current flows through the Zener diode 36 and the resistors 34 and 33 in that order, and flows through the Zener diode 36, and the resistors 34, 32, and 31 in that order.

When a current flows through the cathode and anode of the Zener diode 36 in that order, the voltage at one end of the resistor 31 with respect to the potential of the negative terminal T2 is sufficiently high, and, the voltage at the base with respect to the potential of the emitter of the selector switch 35 is higher than or equal to the second threshold value. In this case, the selector switch 35 is on.

When the selector switch 35 is on, the voltage at the gate of the bypass switch 25 with respect to the potential of the negative terminal T2 is substantially zero V. At this time, the voltage at the gate of the bypass switch 25 with respect to the potential of the source is lower than the first threshold value, which is a positive threshold value, and the bypass switch 25 is off.

As described above, when the connection of the battery 10 is a normal connection, and the battery voltage is higher than or equal to the reference voltage Vr, the selector switch 35 is on and the bypass switch 25 is off, as shown in FIG. 3. Since the bypass switch 25 is off, a current flows through the first switching circuit 21 and the diode 24 in that order, and the voltage that is applied to the first switching circuit 21 is substantially the same as a voltage calculated by subtracting the forward voltage of the diode 24 from the battery voltage.

When the battery voltage drops below the reference voltage Vr, then, the voltage at the cathode with respect to the potential of the anode of the Zener diode 36 drops below the breakdown voltage, and flow of the current through the Zener diode 36 stops. At this time, no current flows through the resistor 33, and thus the voltage at the one end of the resistor 33 with respect to the potential of the negative terminal T2 drops to zero V. At this time, no current flows through the resistor 31 either, and thus, the voltage at the base with respect to the potential of the emitter of the selector switch 35 is zero V, and is lower than the second threshold value, which is a positive value. As a result, the selector switch 35 is switched from on to off.

When the selector switch 35 is switched from on to off, the voltage at the gate of the bypass switch 25 with respect to the potential of the negative terminal T2 rises to a voltage that is close to the output voltage of the regulator 23, and the bypass switch 25 is switched from off to on.

As described above, when the connection of the battery 10 is a normal connection, and the battery voltage drops below the reference voltage Vr, the selector switch 35 is switched from on to off and the bypass switch 25 is switched from off to on, as shown in FIG. 3. When the bypass switch 25 is on, a current flows through the first switching circuit 21 and the bypass switch 25 in that order, and the voltage that is applied to the first switching circuit 21 is substantially the same as the battery voltage.

When the battery voltage rises to the reference voltage Vr or higher, then, the voltage at the cathode with respect to the potential of the anode of the Zener diode 36 rises to the breakdown voltage or higher, and a current flows through the cathode and anode of the Zener diode 36 in that order again. Accordingly, the voltage at the one end of the resistor 33 with respect to the potential of the negative terminal T2 rises to a sufficiently high voltage, and, the voltage at the base with respect to the potential of the emitter of the selector switch 35 rises to the second threshold value or higher. As a result, the selector switch 35 is switched from off to on. When the selector switch 35 is switched from off to on, the bypass switch 25 is switched from on to off, as described above.

As described above, when the connection of the battery 10 is a normal connection, and the battery voltage rises to the reference voltage Vr or higher, the selector switch 35 is switched from off to on and the bypass switch 25 is switched from on to off, as shown in FIG. 3. Accordingly, a current flows through the first switching circuit 21 and the diode 24 in that order again, and the voltage that is applied to the first switching circuit 21 returns to the voltage calculated by subtracting the forward voltage of the diode 24 from the battery voltage.

When the connection of the battery 10 is a reverse connection, a current flows through the negative terminal T2, the resistors 33 and 34, the Zener diode 36, and the positive terminal T1 in that order, and flows through the negative terminal T2, the resistors 31, 32, and 34, the Zener diode 36, and the positive terminal T1 in that order. At this time, the voltage at the base with respect to the potential of the emitter of the selector switch 35 is a negative voltage, and is lower than the second threshold value, which is a positive value. The selector switch 35 is off.

When the connection of the battery 10 is a reverse connection, the regulator 23 does not operate, and no current flows through the resistor 26. Therefore, a voltage is not output from the second switching circuit 22 to the gate of the bypass switch 25. At this time, as described above, the bypass switch 25 is off. When the connection of the battery 10 is a reverse connection, a current flows through the second switching circuit 22, as described above, but there is no problem.

FIG. 4 is a diagram illustrating the effects of the power supply control device 11. In FIG. 4, the thin solid line represents the battery voltage, and the thick solid line represents the voltage that is applied to the first switching circuit 21. Where the battery voltage and the applied voltage are the same, they are indicated by the thick line. The horizontal axis indicates time in the graph of the battery voltage and the graph of the applied voltage. FIG. 4 shows the battery voltage and the applied voltage when the connection of the battery 10 is a normal connection.

As shown in FIG. 4, when the battery voltage is higher than or equal to the reference voltage, the bypass switch 25 is off, and thus a current flows through the first switching circuit 21 and the diode 24 in that order. The voltage that is applied to the first switching circuit 21 is substantially the same as the voltage calculated by subtracting the forward voltage of the diode 24 from the battery voltage. When the battery voltage is lower than the reference voltage, the bypass switch 25 is on, and thus a current flows through the first switching circuit 21 and the bypass switch 25 in that order. The voltage that is applied to the first switching circuit 21 is substantially the same as the battery voltage.

Therefore, when the connection of the battery 10 is a normal connection, and the battery voltage drops below the reference voltage, the bypass switch 25 is switched from off to on, and the applied voltage rises to the battery voltage. Therefore, it is not likely that the applied voltage drops below the operating voltage required for operating the first switching circuit 21 and the operation of the first switching circuit 21 stops.

Note that the reference voltage Vr is preferably higher than or equal to a voltage calculated by adding the forward voltage of the diode 24 to the minimum value of the battery voltage as shown in FIG. 4. In this case, the minimum value of the applied voltage is higher than or equal to the minimum value of the battery voltage, and does not drop below the minimum value of the battery voltage.

A configuration is conceivable in which the diode 24 is disposed on the positive terminal T1 side of the first switching circuit 21 instead of the negative terminal T2 side of the first switching circuit 21, as a configuration in which the operation of the first switching circuit 21 is unlikely to stop. With this configuration, in order to realize the second switching circuit 22 without using a voltage boosting circuit that steps up the battery voltage, an expensive P-channel FET needs to be used as the bypass switch 25, for example.

In the power supply control device 11, the diode 24 is disposed on the negative terminal T2 side of the first switching circuit 21, and thus an inexpensive N-channel FET can be used as the bypass switch 25. Therefore, the manufacturing cost of the power supply control device 11 is low.

Note that a transistor that is used as the selector switch 35 is not limited to an NPN bipolar transistor, and may also be an N-channel FET, for example. In this case, the drain, source, and gate of the FET respectively correspond to the collector, emitter, and base of the bipolar transistor.

### Second Embodiment

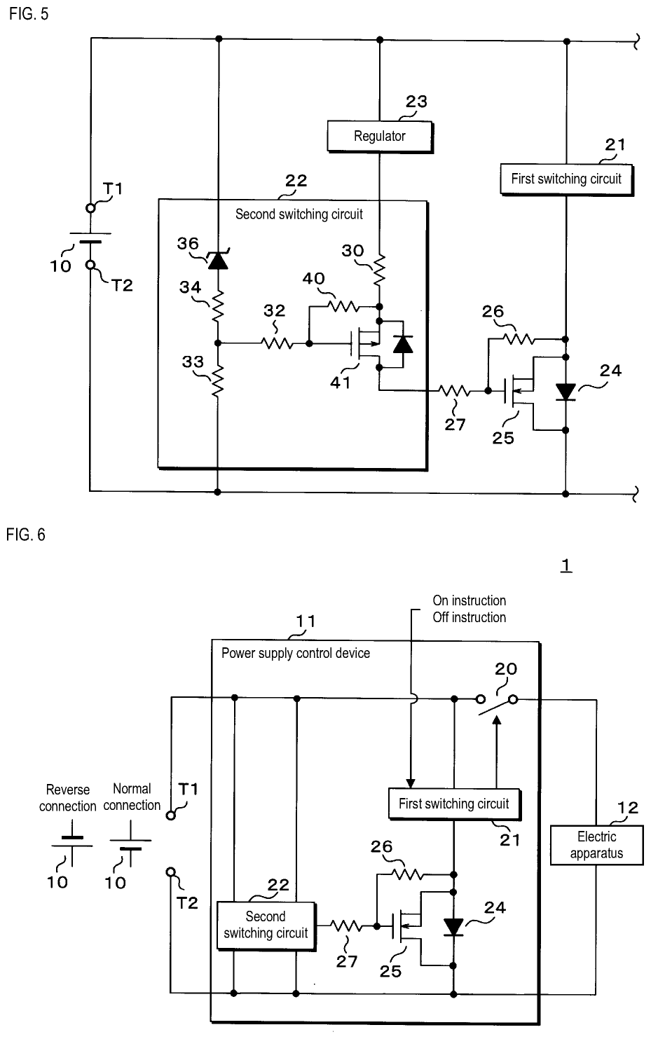

FIG. 5 is a circuit diagram of a second switching circuit 22 according to a second embodiment.

The differences between the first embodiment and the second embodiment will be described below. Constituent elements other than constituent elements to be described later are the same as those in the first embodiment. Therefore, the same reference signs are assigned to the constituent elements that are the same as those in the first embodiment, and a description thereof is omitted.

When the second embodiment is compared with the first embodiment, the configuration of the second switching circuit 22 of the power supply control device 11 is different. According to the second embodiment, the second switching circuit 22 includes the resistors 30, 32 to 34 and the Zener diode 36 similarly to the first embodiment. The second switching circuit 22 includes a resistor 40 and a selector switch 41 instead of the resistor 31 and the selector switch 35. The selector switch 41 is a P-channel FET.

The resistors 33 and 34 and the Zener diode 36 are connected similarly to the first embodiment. One end of the resistor 30 is connected to the regulator 23. The other end of the resistor 30 is connected to the source of the selector switch 41. The drain of the selector switch 41 is connected to the other end of the resistor 27. As described in the first embodiment, the one end of the resistor 27 is connected to the gate of the bypass switch 25. Therefore, the drain of the selector switch 41 is connected to the gate of the bypass switch 25 via the resistor 27. According to the second embodiment, the selector switch 41 functions as a second switch.

The resistor 40 is connected between the gate and the source the selector switch 41. The gate of the selector switch 41 is further connected to one end of the resistor 32. The other end of the resistor 32 is connected to one end of each of the resistors 33 and 34.

When the connection of the battery 10 is a normal connection, the regulator 23 steps down the battery voltage to a set voltage, and applies the stepped-down voltage to the one end of the resistor 30. The stepped-down voltage is a positive voltage with respect to the potential of the negative terminal T2, namely, the potential of the cathode of the diode 24.

When the voltage at the gate with respect to the potential of the source of the selector switch 41 drops, the resistance value between the source and the drain drops. When the voltage at the gate with respect to the potential of the source of the selector switch 41 is lower than or equal to a third threshold value, the resistance value between the source and the drain is low, and a current can flow through the source and drain. At this time, the selector switch 41 is on.

In addition, when the voltage at the gate with respect to the potential of the source of the selector switch 41 exceeds the third threshold value, the resistance value between the source and the drain is high, and no current flows through the source and drain. At this time, the selector switch 41 is off. The third threshold value is a fixed voltage, and is lower than zero V.

The selector switch 41 is switched on or off in accordance with the voltage at the one end of the resistor 33 with respect to the potential of the negative terminal T2. When the voltage at the one end of the resistor 33 with respect to the potential of the negative terminal T2 is higher than or equal to a voltage that is output from the regulator 23, namely a set voltage, no current flows through the resistors 30, 32, and 40. At this time, the voltage at the gate with respect to the potential of the source of the selector switch 41 is zero V, and exceeds the third threshold value, which is a negative value. Therefore, the selector switch 41 is off.

When the voltage at the one end of the resistor 33 with respect to the potential of the negative terminal T2 is lower than the set voltage, a current flows from the regulator 23 to the resistors 30, 40, 32, and 33 in that order, and a voltage drop occurs at the resistor 40. Accordingly, the voltage at the gate with respect to the potential of the source of the selector switch 41 drops. The higher the current flowing through the resistor 40 is, the larger the range of the voltage drop at the resistor 40 is. Also, the larger the range of the voltage drop at the resistor 40 is, the lower the voltage at the gate with respect to the potential of the source is.

Assume that, when the voltage at the one end of the resistor 33 with respect to the potential of the negative terminal T2 is lower than the set voltage, the difference between the voltage at the one end of the resistor 33 and the set voltage is small. In this case, a current flowing through the resistor 40 is small, and thus, the voltage at the gate with respect to the potential of the source of the selector switch 41 exceeds the third threshold value, and the selector switch 41 is off.

Now assume that, when the voltage at the one end of the resistor 33 with respect to the potential of the negative terminal T2 is lower than the set voltage, the difference between the voltage at the one end of the resistor 33 and the set voltage is large. In this case, a current flowing through the resistor 40 is large, and thus, the voltage at the gate with respect to the potential of the source of the selector switch 41 is lower than or equal to the third threshold value, and the selector switch 41 is on.

As described above, when the connection of the battery 10 is a normal connection, and the voltage at the one end of the resistor 33 with respect to the potential of the negative terminal T2 is high, the selector switch 41 is off. When the connection of the battery 10 is a normal connection, and the voltage at the one end of the resistor 33 with respect to the potential of the negative terminal T2 is low, the selector switch 41 is on.

Similarly to the first embodiment, when the connection of the battery 10 is a normal connection, a positive battery voltage with respect to the potential of the negative terminal T2 is applied to the cathode of the Zener diode 36 . When the connection of the battery 10 is a normal connection, and the battery voltage is higher than or equal to the reference voltage Vr, then, the voltage at the cathode with respect to the potential of the anode of the Zener diode 36 is higher than or equal to the breakdown voltage. At this time, a current flows through the Zener diode 36 and the resistors 34 and 33 in that order, and the voltage at the one end of the resistor 33 with respect to the potential of the negative terminal T2 is high. As a result, the selector switch 41 is off.

When the selector switch 41 is off, no voltage is output from the second switching circuit 22 to the gate of the bypass switch 25. In this case, no current flows through the resistor 26, and thus, the voltage at the gate of the bypass switch 25 with respect to the potential of the source is zero V, and is lower than the first threshold value, which is a positive value. Therefore, the bypass switch 25 is off.

When the connection of the battery 10 is a normal connection, and the battery voltage drops below the reference voltage Vr, then, the voltage at the cathode with respect to the potential of the anode of the Zener diode 36 is lower than the breakdown voltage, and the flow of current through the Zener diode 36 stops. At this time, the voltage at the one end of the resistor 33 with respect to the potential of the negative terminal T2 drops to a low voltage, and the selector switch 41 is switched on.

When the selector switch 41 is switched on, the voltage at the gate of the bypass switch 25 with respect to the potential of the negative terminal T2 rises to a voltage that is close to the output voltage of the regulator 23, and the bypass switch 25 is switched on.

When the connection of the battery 10 is a normal connection, and the battery voltage rises to the reference voltage Vr or higher, a current flows through the Zener diode 36 again, and the selector switch 41 is switched off. Accordingly, the bypass switch 25 is also switched off.

As described above, when the connection of the battery 10 is a normal connection, and the battery voltage drops below the reference voltage Vr, the selector switch 41 and the bypass switch 25 are switched from off to on. When the connection of the battery 10 is a normal connection, and the battery voltage rises to the reference voltage Vr or higher, the selector switch 41 and the bypass switch 25 are switched from on to off.

When the connection of the battery 10 is a reverse connection, a current flows through the negative terminal T2, the resistors 33 and 34, the Zener diode 36, and the positive terminal T1 in that order. The cathode of the regulator 23 is connected to the one end of the resistor 30, and thus no current flows through the resistors 30, 32, and 40. At this time, the voltage at the gate with respect to the potential of the source of the selector switch 41 is zero V, and exceeds the third threshold value, which is a negative value. Therefore, the selector switch 41 is off. When the selector switch 41 is off, the bypass switch 25 is off, as described above.

When the connection of the battery 10 is a reverse connection, a current flows through the second switching circuit 22, but there is no problem, as described above.

According to the second embodiment, similarly to the first embodiment, when the connection of the battery 10 is a normal connection, and the battery voltage drops below a reference voltage, the bypass switch 25 is switched from off to on. When the connection of the battery 10 is a normal connection, and the battery voltage rises to the reference voltage or higher, the bypass switch 25 is switched from on to off. When the connection of the battery 10 is a reverse connection, the bypass switch 25 is off. Therefore, the power supply control device 11 according to the second embodiment has the same effects as the power supply control device 11 according to the first embodiment.

Note that the transistor that is used as the selector switch 41 is not limited to a P-channel FET, and may also be a PNP bipolar transistor, for example. In this case, the emitter, collector, and base of the bipolar transistor respectively correspond to the source, drain, and gate of the FET.

### Third Embodiment

FIG. 6 is a block diagram showing the main constituent elements of a power source system 1 according to a third embodiment.

The differences between the first embodiment and the third embodiment will be described below. Constituent elements other than constituent elements to be described later are the same as those in the first embodiment. Therefore, the same reference signs are assigned to the constituent elements that are the same as those in the first embodiment, and a description thereof is omitted.

The first and third embodiments are different in whether or not the power supply control device 11 includes the regulator 23. The power supply control device 11 according to the third embodiment includes the constituent elements of the power supply control device 11 according to the first embodiment, other than the regulator 23. The other end of the resistor 30 of the second switching circuit 22 is connected to one end of the power supply switch 20.

When the connection of the battery 10 is a normal connection, and the battery voltage is higher than or equal to a reference voltage, the selector switch 35 is on and the bypass switch 25 is off, similarly to the first embodiment.

When the connection of the battery 10 is a normal connection, and the battery voltage drops below the reference voltage, the selector switch 35 is switched from on to off, similarly to the first embodiment. When the selector switch 35 is switched off, the voltage at the gate of the bypass switch 25 with respect to the potential of the negative terminal T2 rises to a voltage that is close to the battery voltage, and the bypass switch 25 is switched on.

When the connection of the battery 10 is a normal connection, and the battery voltage rises to the reference voltage or higher, the selector switch 35 is switched from off to on, and the bypass switch 25 is switched from on to off, similarly to the first embodiment.

When the connection of the battery 10 is a reverse connection, the selector switch 35 and the bypass switch 25 are off, similarly to the first embodiment.

According to the third embodiment, the selector switch 35 and the bypass switch 25 are switched on and off similarly to the first embodiment. Therefore, the power supply control device 11 according to the third embodiment has the same effects as the power supply control device 11 according to the first embodiment.

### Fourth Embodiment

The configuration of the second switching circuit 22 according to the third embodiment is not limited to the configuration of the second switching circuit 22 according to the first embodiment.

The differences between the third embodiment and the fourth embodiment will be described below. Constituent elements other than constituent elements to be described later are the same as those in the third embodiment. Therefore, the same reference signs are assigned to the constituent elements that are the same as those in the third embodiment, and a description thereof is omitted.

The configuration of the second switching circuit 22 according to the fourth embodiment is similar to the configuration of the second switching circuit 22 according to the second embodiment (see FIG. 5). In the power supply control device 11 according to the fourth embodiment, the one end of the resistor 30 of the second switching circuit 22 is connected to the one end of the power supply switch 20.

When the connection of the battery 10 is a normal connection, and the voltage at the one end of the resistor 33 with respect to the potential of the negative terminal T2 is high, the selector switch 41 is off similarly to the second embodiment. When the connection of the battery 10 is a normal connection, and the voltage at the one end of the resistor 33 with respect to the potential of the negative terminal T2 is low, the selector switch 41 is on similarly to the second embodiment.

When the connection of the battery 10 is a normal connection, and the battery voltage is higher than or equal to a reference voltage, the voltage at the one end of the resistor 33 with respect to the potential of the negative terminal T2 is high, and the selector switch 41 is off. When the selector switch 41 is off, the bypass switch 25 is off similarly to the second embodiment.

When the connection of the battery 10 is a normal connection, and the battery voltage drops below the reference voltage, the voltage at the one end of the resistor 33 with respect to the potential of the negative terminal T2 drops, and the selector switch 41 is switched from off to on similarly to the second embodiment. When the selector switch 41 is switched on, the voltage at the gate of the bypass switch 25 with respect to the potential of the negative terminal T2 rises to a voltage that is close to the battery voltage, and the bypass switch 25 is switched on.

When the connection of the battery 10 is a normal connection, and the battery voltage rises to the reference voltage or higher, the voltage at the one end of the resistor 33 with respect to the potential of the negative terminal T2 rises, and, similarly to the second embodiment, the selector switch 41 is switched from on to off, and the bypass switch 25 is also switched from on to off.

When the connection of the battery 10 is a reverse connection, a current flows through the negative terminal T2, the resistors 33 and 34, the Zener diode 36, and the positive terminal T1 in that order, and flows through the negative terminal T2, the resistors 33, 32, 40, and 30, and the positive terminal T1 in that order. At this time, the voltage at the gate with respect to the potential of the source of the selector switch 41 is a positive voltage, and is higher than or equal to the third threshold value, which is a negative value. Therefore, the selector switch 41 is off. When the selector switch 41 is off, the bypass switch 25 is also off, similarly to the second embodiment.

According to the fourth embodiment, the selector switch 41 and the bypass switch 25 are switched on and off similarly to the second embodiment. Therefore, the power supply control device 11 according to the fourth embodiment has the same effects as the power supply control device 11 according to the second embodiment.

### Fifth Embodiment

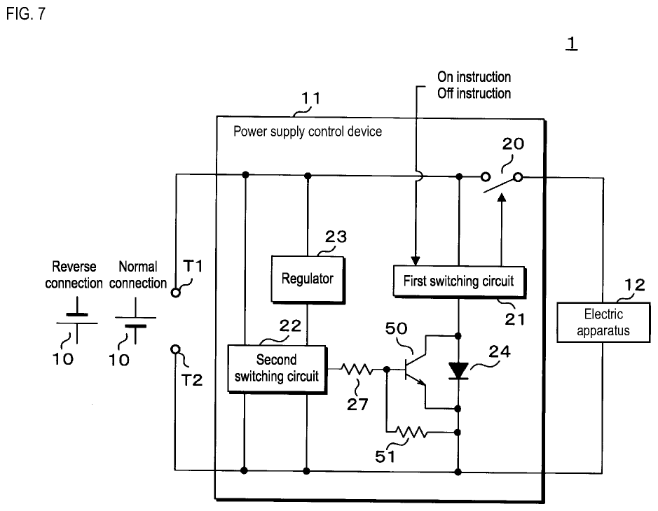

FIG. 7 is a block diagram showing the main constituent elements of a power source system 1 according to a fifth embodiment.

The differences between the first embodiment and the fifth embodiment will be described below. Constituent elements other than constituent elements to be described later are the same as those in the first embodiment. Therefore, the same reference signs are assigned to the constituent elements that are the same as those in the first embodiment, and a description thereof is omitted.

When the fifth embodiment is compared with the first embodiment, a different transistor is used as a bypass switch. The power supply control device 11 according to the fifth embodiment includes the constituent elements of the power supply control device 11 according to the first embodiment, other than the bypass switch 25 and the resistor 26. The power supply control device 11 according to the fifth embodiment includes a bypass switch 50 and a resistor 51 instead of the bypass switch 25 and the resistor 26.

The bypass switch 50 is an NPN bipolar transistor. When a bipolar transistor is manufactured, no parasitic diode is generated. Therefore, the diode 24 according to the third embodiment is a normal element.

The collector and emitter of the bypass switch 50 are respectively connected to the anode and cathode of the diode 24. The resistor 51 is connected between the base and the emitter of the bypass switch 50. The base of the bypass switch 50 is further connected to one end of the resistor 27.

When the voltage at the base with respect to the potential of the emitter of the bypass switch 50 rises, the resistance value between the collector and the emitter drops. When the voltage at the base with respect to the potential of the emitter of the bypass switch 50 is higher than or equal to a fourth threshold value, the resistance value between the collector and the emitter is small, and a current can flow through the collector and emitter. At this time, the bypass switch 50 is on.

In addition, when the voltage at the base with respect to the potential of the emitter of the bypass switch 50 is lower than the fourth threshold value, the resistance value between the collector and the emitter is high, and no current flows through the collector and emitter. At this time, the bypass switch 50 is off. The fourth threshold value is a fixed voltage, and exceeds zero V.

When the connection of the battery 10 is a normal connection, and the battery voltage is higher than or equal to a reference voltage, the selector switch 35 of the second switching circuit 22 (see FIG. 2) is on, similarly to the first embodiment. At this time, no current flows through the resistor 51, and, the voltage at the base with respect to the potential of the emitter of the bypass switch 50 is zero V, and is lower than the fourth threshold value, which is a positive value. As a result, the bypass switch 50 is off.

When the connection of the battery 10 is a normal connection, and the battery voltage drops below the reference voltage, the selector switch 35 is switched from on to off, similarly to the first embodiment. When the selector switch 35 is switched off, then, the voltage at the base of the bypass switch 50 with respect to the potential of the emitter of the bypass switch 50 rises to a voltage that is close to the output voltage of the regulator 23, and reaches at least the fourth threshold value. As a result, the bypass switch 50 is switched from off to on.

When the connection of the battery 10 is a normal connection, and the battery voltage rises to the reference voltage or higher, the selector switch 35 is switched from off to on and the bypass switch 50 is switched from on to off, similarly to the first embodiment.

When the connection of the battery 10 is a reverse connection, the selector switch 35 is off, similarly to the first embodiment. In addition, the diode of the regulator 23 is connected to the other end of the resistor 30, and thus, when the connection of the battery 10 is a reverse connection, no current flows through the resistor 51, and the bypass switch 50 is also off.

According to the fifth embodiment, switching on and off of the selector switch 35 and the bypass switch 50 is similar to switching on and off of the selector switch 35 and the bypass switch 25 according to the first embodiment. Therefore, the power supply control device 11 according to the fifth embodiment has the same effects as the power supply control device 11 according to the first embodiment.

Note that, in the power supply control device 11 according to the fifth embodiment, the regulator 23 may be omitted as in the third embodiment. In this case, switching on and off of the selector switch 35 and the bypass switch 50 is similar to switching on and off of the selector switch 35 and the bypass switch 25 according to the third embodiment. When the connection of the battery 10 is a reverse connection, a current flows through the negative terminal T2, the resistor 51, 27, 30, and the positive terminal T1 in that order. At this time, the voltage at the base with respect to the potential of the emitter of the bypass switch 50 is a negative voltage, and is lower than the fourth threshold value, which is a positive value. As a result, the bypass switch 50 is off.

### Sixth Embodiment

The configuration of the second switching circuit 22 according to the fifth embodiment is not limited to the configuration of the second switching circuit 22 according to the first embodiment.

The differences between the fifth embodiment and the sixth embodiment will be described below. Constituent elements other than constituent elements to be described later are the same as those in the fifth embodiment. Therefore, the same reference signs are assigned to the constituent elements that are the same as those in the fifth embodiment, and a description thereof is omitted.

The configuration of the second switching circuit 22 according to the sixth embodiment is similar to the configuration of the second switching circuit 22 according to the second embodiment (see FIG. 5).

When the connection of the battery 10 is a normal connection, and the battery voltage is higher than or equal to a reference voltage, the selector switch 41 of the second switching circuit 22 is off similarly to the second embodiment. At this time, no current flows through the resistor 51, and the bypass switch 50 is off.

When the connection of the battery 10 is a normal connection, and the battery voltage drops below the reference voltage, the selector switch 41 is switched from off to on, similarly to the second embodiment. When the selector switch 41 is switched on, then the voltage at the base of the bypass switch 50 with respect to the potential of the emitter of the bypass switch 50 rises to a voltage that is close to the output voltage of the regulator 23, and reaches at least the fourth threshold value. As a result, the bypass switch 50 is switched from off to on.

When the connection of the battery 10 is a normal connection, and the battery voltage rises to the reference voltage or higher, the selector switch 41 is switched from on to off and the bypass switch 50 is switched from on to off, similarly to the second embodiment.

When the connection of the battery 10 is a reverse connection, the selector switch 41 is off similarly to the second embodiment. In addition, the diode of the regulator 23 is connected to the one end of the resistor 30, and thus, when the connection of the battery 10 is a reverse connection, no current flows through the resistor 51, and the bypass switch 50 is also off.

According to the sixth embodiment, switching on and off of the selector switch 41 and the bypass switch 50 is similar to switching on and off of the selector switch 41 and the bypass switch 25 according to the second embodiment. Therefore, the power supply control device 11 according to the sixth embodiment has the same effects as the power supply control device 11 according to the second embodiment.

Note that, in the power supply control device 11 according to the sixth embodiment, the regulator 23 may be omitted as in the fourth embodiment. In this case, switching on and off of the selector switch 41 and the bypass switch 50 is similar to switching on and off of the selector switch 41 and the bypass switch 25 according to the fourth embodiment. When the connection of the battery 10 is a reverse connection, a current flows through the negative terminal T2, the resistor 51, 27, and 30, and the positive terminal T1 in that order. At this time, the voltage at the base with respect to the potential of the emitter of the bypass switch 50 is a negative voltage, and is lower than the fourth threshold value, which is a positive value. As a result, the bypass switch 50 is off.

Note that, in the first to sixth embodiments, the electric circuit disposed upstream of the diode 24 on the supply path through which the battery 10 supplies power is not limited to the first switching circuit 21. It suffices for the electric circuit that is disposed upstream of the diode 24 to be a circuit that operates when power is supplied from the battery 10.

The disclosed first to sixth embodiments are to be considered as illustrative and non-limiting in all aspects. The scope of the present disclosure is indicated not by the above-stated meanings but by the claims, and is intended to include all modifications that are within the meanings and the scope that are equivalent to those of the claims.

1. A circuit device that includes an electric circuit that is supplied with power when a DC voltage is applied between two terminals thereof, the circuit device comprising:
a diode that is disposed on a supply path for supplying power to the electric circuit;
a switch that is connected to two ends of the diode; and
a switching circuit that switches the switch from off to on when the DC voltage is applied in a specific direction and drops below a predetermined voltage,
wherein, when the DC voltage is applied in the specific direction, and the switch is off, a current flows through the electric circuit and the diode in that order.

2. The circuit device according to claim 1,
wherein the switch is a transistor,
the switch includes:
a first end that is disposed on an anode side of the diode on the supply path,
a second end that is disposed on a cathode side of the diode on the supply path, and
a third end,
when a voltage at the third end rises, a resistance value between the first end and the second end drops, and
the switching circuit switches the switch from off to on by raising the voltage at the third end.

3. The circuit device according to claim 2,
wherein the switch is an N-channel FET, and
the diode is a parasitic diode of the switch.

4. The circuit device according to claim 2, wherein the switching circuit includes:
a resistor whose one end is connected to the third end of the switch, and
a second switch whose one end is connected to the third end of the switch,
when the DC voltage is applied in the specific direction, a positive voltage with respect to a potential of another end of the second switch is applied to the other end of the resistor, and
when the DC voltage is applied in the specific direction, and the DC voltage drops below a predetermined voltage, the second switch is switched from on to off.

5. The circuit device according to claim 2, wherein the switching circuit includes a second switch whose one end is connected to the third end of the switch,
when the DC voltage is applied in the specific direction, a positive voltage with respect to a potential of a cathode of the diode is applied to another end of the second switch, and
when the DC voltage is applied in the specific direction and drops below a predetermined voltage, the second switch is switched from off to on.

6. The circuit device according to claim 4,
wherein the switching circuit includes:
a Zener diode, and
a second resistor whose one end is connected to an anode of the Zener diode,
when the DC voltage is applied in the specific direction, a positive voltage with respect to a potential of the other end of the second resistor is applied to a cathode of the Zener diode, and
the second switch is switched on or off in accordance with a voltage at the one end of the second resistor.

7. The circuit device according claim 1, further comprising:
a third switch,
wherein the electric circuit switches the third switch on or off, and
when the DC voltage is applied to the two terminals, power is supplied to an electric apparatus via the third switch.

8. The circuit device according to claim 3, wherein the switching circuit includes:
a resistor whose one end is connected to the third end of the switch, and
a second switch whose one end is connected to the third end of the switch,
when the DC voltage is applied in the specific direction, a positive voltage with respect to a potential of another end of the second switch is applied to the other end of the resistor, and
when the DC voltage is applied in the specific direction, and the DC voltage drops below a predetermined voltage, the second switch is switched from on to off.

9. The circuit device according to claim 3, wherein the switching circuit includes a second switch whose one end is connected to the third end of the switch,
when the DC voltage is applied in the specific direction, a positive voltage with respect to a potential of a cathode of the diode is applied to another end of the second switch, and
when the DC voltage is applied in the specific direction and drops below a predetermined voltage, the second switch is switched from off to on.

10. The circuit device according to claim 5,
wherein the switching circuit includes:
a Zener diode, and
a second resistor whose one end is connected to an anode of the Zener diode,
when the DC voltage is applied in the specific direction, a positive voltage with respect to a potential of the other end of the second resistor is applied to a cathode of the Zener diode, and
the second switch is switched on or off in accordance with a voltage at the one end of the second resistor.

11. The circuit device according claim 2, further comprising:
a third switch,
wherein the electric circuit switches the third switch on or off, and
when the DC voltage is applied to the two terminals, power is supplied to an electric apparatus via the third switch.

12. The circuit device according claim 3, further comprising:
a third switch,
wherein the electric circuit switches the third switch on or off, and
when the DC voltage is applied to the two terminals, power is supplied to an electric apparatus via the third switch.

13. The circuit device according claim 4, further comprising:
a third switch,
wherein the electric circuit switches the third switch on or off, and
when the DC voltage is applied to the two terminals, power is supplied to an electric apparatus via the third switch.

14. The circuit device according claim 5, further comprising:
a third switch,
wherein the electric circuit switches the third switch on or off, and
when the DC voltage is applied to the two terminals, power is supplied to an electric apparatus via the third switch.

16. The circuit device according claim 6, further comprising:
a third switch,
wherein the electric circuit switches the third switch on or off, and
when the DC voltage is applied to the two terminals, power is supplied to an electric apparatus via the third switch.
